(19) United States
(12) Patent Application Publication
(10) Pub. No.: US 2010/0082063 A1
(43) Pub. Date: Apr. 1, 2010

(54) Pacifier Tether

(76) Inventors: Nicole Yacktman, Lakeway, TX (US); Robert Yacktman, Lakeway, TX (US)

Correspondence Address: Nicole Yacktman, Ste. 135-222, 2303 Ranch Road 620 S., Lakeway, TX, 78734, US

(21) Appl. No.: 12/563,121

(22) Filed: Sep. 19, 2009

Related U.S. Application Data
(60) Provisional application No. 61/098,515, filed on Sep. 19, 2008.

(51) Int. Cl. A61J 17/00

(52) U.S. Cl. 606/234

(57) ABSTRACT

A pacifier tether includes a ring or aperture at one end to be interposed between two halves of a fastener such as a button and button hole or two halves of a snap on an infant garment. The tether is connected to the infant garment by completing the buttoning or snap fastening about the ring on the tether to secure the ring between the fastened garment layers. A second ring or aperture at a second tether end is configured to allow passage of the other tether end to form a loop about a pacifier handle. Alternatively, the tether is connected to the pacifier by a hook and loop touch fastener, snap fastener, or snap fit. A snap adapter on the tether can be used to engage each of two halves of a snap on the infant garment.

### CLAIM OF PRIORITY

The application claims priority to provisional application Ser. No. 61098515 filed Sep. 19, 2008, the entire contents of which are hereby incorporated by reference.

### TECHNICAL FIELD

The present invention relates generally to safety pacifier tethers.

### BACKGROUND

Pacifier tethers generally include cords or straps used to fasten a pacifier to a garment. Existing pacifier tethers often include some form of alligator clip at one end for clipping the tether to an infant garment. Such clips are generally bulky and include hard edges making it uncomfortable if the infant rests on top of the clip. Moreover, many such clips will separate from the garment with a nominal pulling force. Still other clips can snag or tear the garment. Accordingly, such clips are potentially uncomfortable and unreliable.

Some earlier proposed pacifier tethers have not been approved or have been recalled by the Consumer Product Safety Commission for failure to meet minimum safety standards for infant use. For example, some prior art tethers presented dangers due to unduly long tethers, use of toxic materials or presence of hard edges that can harm an infant if the infant chews on them.

Accordingly, improvements are sought in safety and comfort in tethering a pacifier to an infant.

### SUMMARY

One aspect of the invention features a tether strap having first and second ends and first and second rings or apertures at the respective first and second tether strap ends.

In some implementations, the first ring is configured to be interposed between first and second halves of a garment fastening, e.g., a button and button hole or two halves of a snap.

In some implementations, the tether strap includes a snap fastener adapter for interposition between the two halves of a snap fastener on an infant garment.

Another aspect of the invention features first and second rings constructed and arranged such that one of the first and second rings passes through the other of the first and second rings to form a loop in the tether strap. In some implementations, one or both rings are pliable to enable passage of one ring through another. In some implementations, the loop in the tether strap serves to retain a portion of a pacifier such as a pacifier handle.

The tether serves to secure the pacifier to the infant, even when the pacifier is not in use, and to do so without placing undue strain upon the clothing material.

In some implementations, the pacifier tether includes a circular plastic ring to be placed between the garment button and button hole or between two halves of a snap to hold the end of the device to the child. The strap is connected to the infant garment at one end with the ring and a second fastening device such as a touch fastener or snap fastener is connected at the other end of the strap to a pacifier.

In some implementations, the ring is a non-toxic synthetic plastic material, and the strap is comprised of comfortable and resilient cloth material.

In some implementations, the rings are plastic, rubber or metal. In some implementations, the strap end is wrapped around the ring and sewn to secure the ring and strap together.

In some implementations, the fastener at the remote end of the strap comprises a hook and loop-type touch fastener that is looped through the end of the pacifier for fastening a conventional pacifier.

In some implementations, the tether includes an aligator clip defining a tether retainer. In some cases, the tether retainer is a projection sized to receive one of the first and second rings thereon. In a particular case, the projection includes a head portion of a larger diameter than an inner diameter of the one of the first and second rings fitted thereon.

In some implementations, the tether retainer includes a fastening configured to be made through one of the first and second rings. In some cases, the tether retainer includes a second strap configured to be inserted through one of the first and second rings.

Another aspect of the invention features a pacifier tether including a strap having a length defined by first and second ends and an aperture defined at the first end and configured for insertion between two halves of a fastening on an infant garment. A pacifier retainer is formed at the second end. In some implementations, the aperture is a pliable ring.

In some implementations, the pacifier retainer defines a second aperture, wherein one of the first and second ends is insertable through one of the first and second apertures whereby a loop is formed in the strap to retain a portion of a pacifier.

In some implementations, the pacifier retainer includes a touch fastener.

In some implementations, the pacifier retainer includes a loop formed in the strap.

Another aspect of the invention features a method of retaining a pacifier. The method includes providing a pacifier to be retained; providing a tether having first and second ends and defining a first aperture at the first end; attaching the pacifier to the second end of the tether; and forming a fastening on an infant garment through the first aperture defined on the tether to retain the pacifier on the garment.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 is a front view of a pacifier tether securing a pacifier to an infant garment.

FIG. 2 is a front view of a pacifier tether.

FIG. 3 is a front view of a pacifier tether to be interposed between garment layers in a garment fastening.

FIG. 4A is a front view of additional pacifier attachment.

FIG. 4B is a front view of additional pacifier attachment.

FIG. 5 is a front view of another tether to garment attachment.

FIG. 6 is a perspective view of another tether to garment retainer.

FIG. 7 is a perspective view of another tether to garment retainer.

Like reference symbols in the various drawings indicate like elements.

### DETAILED DESCRIPTION

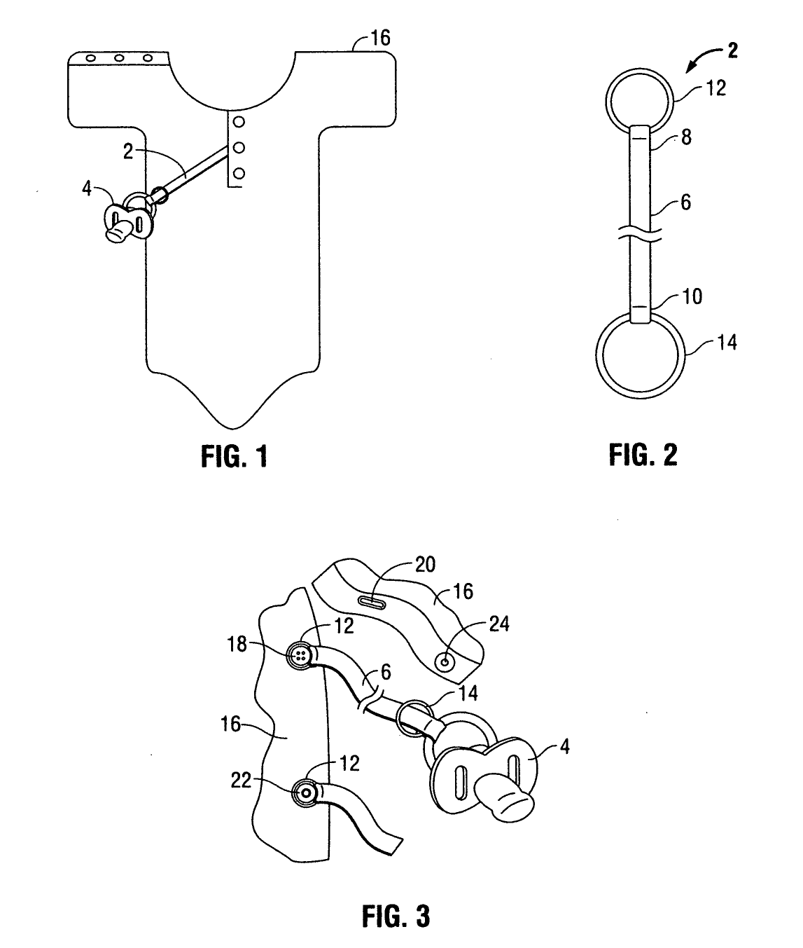

With reference to FIGS. 1-5, a pacifier tether 2 connects a pacifier 4 by a strap 6 having a first end 12 configured to be connected to an infant garment 16 and a second end 10 configured to be connected to the pacifier 4.

With reference to FIGS. 2-3, retained at first end 8 of strap 6 is a ring 12 configured to be inserted between two halves 18 and 20, or 22 and 24 of a fastener on infant garment 16. Second end 10 of strap 6 includes a second ring 14 sized to allow passage of ring 12 therethrough to allow formation of a loop in strap 6 about a handle feature of pacifier 4. Second ring 14 can be constructed with an interior dimension larger than an exterior dimension of first ring 10. Alternatively, second ring 14 can be pliable to allow for deformation of second ring 14 to provide an enlarged interior dimension greater than an exterior dimension of the first ring 10.

Ring 12 can be sized to be larger than either half of a garment fastening and still be retained between the respective fabric layers of the garment associated with each half of the fastening. Ring 12 need not be circular or of uniform cross-section, but may be of any apertured configuration suitable to allow for secure insertion between two halves of a fastener of a garment. Ring 12 can be molded, formed or otherwise made from plastic, metal, or suitable non-toxic material. A pliable material such as rubber may be advantageous in some implementations to further increase comfort of the infant when lying on the ring. The color, texture or other visual attributes of ring 12 can be selected to complement the tether strap 6 or infant garment 16. Rings 12 or 14 can be sewn to the end of a strap of non-toxic cloth material.

Strap 6 can be a cloth, ribbon, cord or elongated plastic strand of suitable flexibility and strength to comfortably secure pacifier 4 to infant garment 16. Strap 6 can be adjustable or of a fixed length. Strap 6 can be partially dynamic to allow for some stretching.

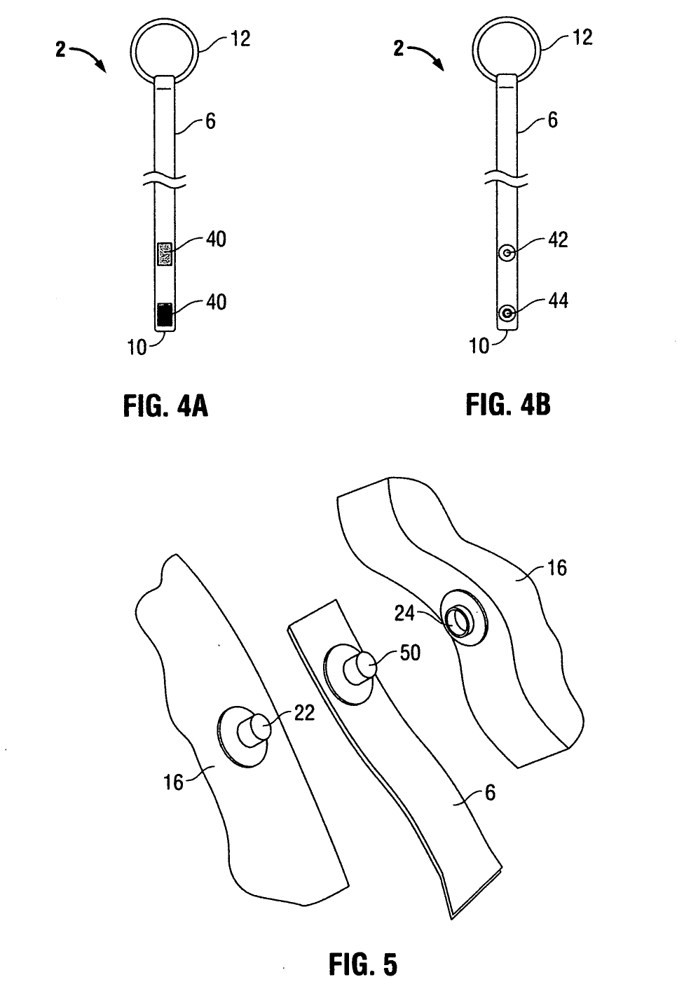

With reference to FIGS. 4a-b, strap 6 can be attachable to pacifier 4 at end 10 by one or more of a hook and loop touch fastener 40, snap fastener 18, 20, snap-fit or other suitable connection or fastening. In an alternative embodiment, one or more of rings 12 and 14 can be formed as an aperture in the end of first or second ends 8 or 10.

With reference to FIG. 5, one or more snap adapters 50 are provided for mating with two halves 22 and 24 of a snap fastening on infant garment 16. For example, adapter 50 includes male and female parts of a snap on opposite sides to mate with halves 22 and 24 on garment 16. Still in other implementations, any combination of the described fasteners or other attachments means may be used at either end of strap 6.

End 10 of strap 6 is looped through the handle of pacifier 4 and folded back for connection via the touch fastener 40 or snap 42, 44 to attach pacifier 4 to strap 6. These fasteners may easily be unfastened while end 8 remains connected to garment 16 so that different pacifiers may be substituted on pacifier tether 2.

In one method of tethering pacifier 4 to infant garment 16, ring 12 is passed through the handle of pacifier 4 and through ring 14 to form a loop in strap 6. Ring 12 is then placed over a button 18 or snap half 22 to lie against the adjacent fabric of garment 16. The fabric portion of garment 16 defining a button hole 20 or carrying complimentary snap half 24 is then placed over ring 12 and button 18 is fastened through button hole 20 or snap halves 22 and 24 are pressed into locking engagement. Ring 12 is at least partially obscured by the top layer of garment 16. Thus, tether 2 is securely attached to garment 16 without the need for a bulky alligator clip. Use of a pliable material for ring 12 is further advantageous in providing increased comfort.

With the pacifier tether ring 12 connected to infant garment 16, pacifier 4 remains tethered to the infant within easy reach for the infant to place pacifier 4 in its mouth. The components of pacifier tether 2 are preferably formed from non-toxic materials. Pacifier tether 2 can be easily removed from an infant's clothing for washing.

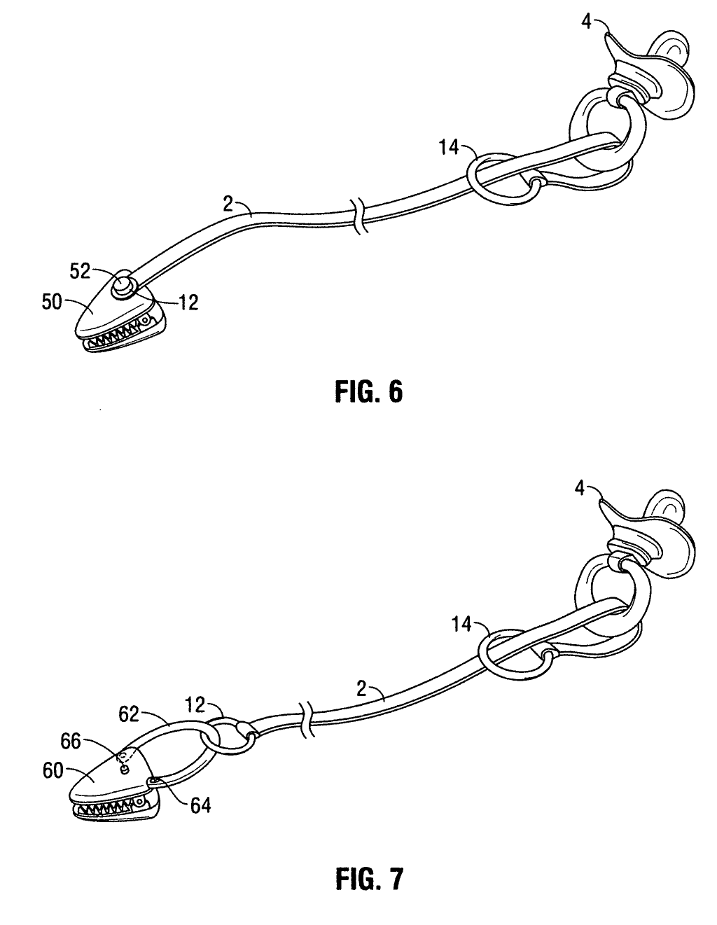

With reference to FIG. 6, another implementation of tether 2 cooperates with or includes an clip 50 defining a projection 52 or stud thereon. Projection 52 is configured to retain one end of tether 2 thereon, for example, by an interference fit between an outer diameter of a head of projection 52 and an inner diameter of ring 12. This arrangement can be advantageous for use with garments that do not have a fastening to receive ring 12 therein.

Alternatively, an aperture may be provided on clip 50 and tether 2 formed in a loop through the aperture as described above with regard to connection to the pacifier.

FIG. 7 is a perspective view of another implementation including a clip 60 having a tether retainer 62 thereon. Retainer 62 is configured to receive ring 12 or other aperture or loop in tether 2. Retainer 62 can include fasteners 64, 66 to secure tether 2 to clip 60. Alternatively, ring 12 or other tether aperture can be inserted between fasteners 64 and 66 as described above with regard to garment fastenings.

A number of implementations of the invention have been described. Nevertheless, it will be understood that various modifications may be made without departing from the spirit and scope of the invention. For example, ring 14 may be configured as an aperture or reinforced slit in an end of strap 6 configured to allow passage of ring 12 and end 8 to form a loop about a handle portion of pacifier 4. Accordingly, other implementations or embodiments are within the scope of the following claims.

What is claimed is:

1. A pacifier tether, comprising
a strap defining a first end to be connected to an infant garment and a second end to be connected to a pacifier;
a ring disposed at the first strap end and configured to be interposed between two halves of an infant garment fastening; and
one of a fastener and a second ring at the second end for attachment to the pacifier.

2. The pacifier tether of claim 1, wherein the ring is configured to be interposed between a button and button hole or between two halves of a snap fastener.

3. The pacifier tether of claim 1, comprising the second ring, wherein one of the first and second rings is configured to be passed through the other of the first and second rings to form a loop in the strap to secure the pacifier at one end of the strap.

4. The pacifier tether of claim 3, wherein one of the first and second rings is sufficiently pliable to be deformable to allow passage of the one of the first and second rings through the other of the first and second rings.

5. The pacifier tether of claim 1, comprising the second ring, wherein one of the first and second rings is defined by one of an aperture and a loopr formed in the strap.

6. The pacifier tether of claim 1, wherein the ring is formed of synthetic plastic material.

7. The pacifier tether of claim 6, wherein the second ring includes an internal dimension sized to pass the first ring to form a loop configured to secure a pacifier handle.

8. The pacifier tether of claim 1, comprising the fastener and wherein the fastener comprises a hook and loop touch fastener.

9. The pacifier tether of claim 1 further comprising a snap adapter disposed on one end of the strap and configured to be interposed between complimentary halves of a snap on an infant garment.

10. The pacifier tether of claim 1, further comprising an aligator clip defining a tether retainer thereon.

11. The pacifier tether of claim 10, wherein the tether retainer comprises a projection sized to receive one of the first and second rings thereon.

12. The pacifier tether of claim 11, wherein the projection includes a head portion of a larger diameter than an inner diameter of the one of the first and second rings fitted thereon.

13. The pacifier tether of claim 10, wherein the tether retainer comprises a fastening configured to be made through one of the first and second rings.

14. The pacifier tether of claim 10, wherein the tether retainer comprises a second strap configured to be inserted through one of the first and second rings.

15. A pacifier tether comprising:
a strap having a length defined by first and second ends;
an aperture defined at the first end and configured for insertion between two halves of a fastening on an infant garment; and
a pacifier retainer at the second end.

16. The pacifier tether of claim 15, wherein the aperture is a pliable ring.

17. The pacifier tether of claim 15, wherein the pacifier retainer defines a second aperture, wherein one of the first and second ends is insertable through one of the first and second apertures whereby a loop is formed in the strap to retain a portion of a pacifier.

18. The pacifier tether of claim 15, wherein the pacifier retainer comprises a touch fastener.

19. The pacifier tether of claim 15, wherein the pacifier retainer comprises loop formed in the strap.

20. A method of retaining a pacifier, the method comprising:
providing a pacifier to be retained;
providing a tether having first and second ends and defining a first aperture at the first end;
attaching the pacifier to the second end of the tether; and
forming a fastening on an infant garment through the first aperture defined on the tether to retain the pacifier on the garment.
